(19) United States
(12) Patent Application Publication
(10) Pub. No.: US 2014/0286287 A1
(43) Pub. Date: Sep. 25, 2014

(54) Device, System and Method for Synchronising Send and Receive States of Wlan Clients in Multilink Wireless Data Transmission

(71) Applicant: Siemens Aktiengesellschaft, Muenchen (DE)

(72) Inventors: Mattias Lampe, Beijing (CN); Ji Feng Tian, Beijing (CN)

(21) Appl. No.: 14/355,716

(22) PCT Filed: Oct. 31, 2012
(86) PCT No.: PCT/EP2012/071538

§ 371 Date: May 1, 2014

(30) Foreign Application Priority Data
Nov. 2, 2011 (CN) CN201110341439.7

(51) Int. Cl. H04W 72/04

(52) U.S. Cl. CPC H04W 72/048
USPC 370/329

(57) ABSTRACT

A multilink wireless data transmission device comprises a control module and two or more WLAN clients. The control module is configured to control said WLAN clients to enable the data transmission states of those of the WLAN clients, which are not in an idle state, to be the same. The data transmission states comprise a receiving state and a sending state. The control module is configured to control at least one of the two or more WLAN clients, which need to receive data, to switch to the receiving state when a downlink triggering condition is met. The control module is further configured to control at least one of the two or more WLAN clients, which need to send data, to switch to the sending state when an uplink triggering condition is met.

### CROSS-REFERENCE TO RELATED APPLICATIONS

This is a U.S. national stage of PCT Application No. PCT/EP2012/071538, filed on Oct. 31, 2012, which claims priority to Chinese Patent Application No. 201110341439.7, filed on Nov. 2, 2011, each of which is hereby incorporated in its entirety by reference.

### FIELD OF THE INVENTION

The present invention relates to the field of wireless data transmission, and particularly to a device, system and method for multilink wireless data transmission.

### DESCRIPTION OF THE RELATED ART

In a wireless local area network (WLAN) system, a wireless communication module (referred to as WLAN client herein) running in a client mode interacts with an access point (referred to as AP hereinafter). With the development of technology, the size of the wireless communication module is becoming smaller and smaller, and the power consumption is becoming lower and lower as well. Therefore, a plurality of such WLAN clients can be integrated into one device, thereby forming a multilink WLAN system.

FIG. 1 shows the structure of a multilink wireless local area network. As shown in FIG. 1, two WLAN clients are located on an identical communication device, respectively illustrated as Client1 and Client2. In a multilink wireless local area network, each WLAN client is associated with a different access point, as shown in FIG. 1. The multilink wireless local area network comprises two access points, respectively being AP1 and AP2, wherein Client1 is associated with AP1, and Client2 is associated with AP2.

Since two or more WLAN clients are included on one device and each WLAN client can perform data transmission, when compared to a device including only one WLAN client, applying a multilink wireless local area network can increase the data throughput transmitted by each device and improve the flexibility of data transmission. However, when two or more WLAN clients are located on an identical device, there must be mutual interference among the two or more WLAN clients.

Generally, in order to avoid co-channel interference, different wireless communication modules work on different channels. However, in practical applications, the interference among wireless communication modules working on different channels is still very serious. For example, using inaccurate channel filters in wireless communication modules can bring interference. In addition, the distance between two wireless communication modules or two radio frequency (RF) components corresponding to two wireless communication modules being too close and the absence of appropriate RF shielding will also bring heavy interference. The interference above will result in a great loss of data throughput, degenerate system functions, and even cause the performance of the multilink wireless local area network degraded to the level of a single-link wireless local area network. Therefore, the interference problem among wireless communication modules seriously restricts the application of the multilink wireless local area network.

In order to solve the interference problem, an existing method is to increase the distance between a plurality of wireless communication modules on an identical device, or employ more effective RF shielding among the plurality of wireless communication modules. However, when the space on the device is limited, it is impossible to make the distance between the plurality of wireless communication modules far enough. In addition, employing more effective RF shielding will significantly increase the costs. Another existing method is to re-design antennas for a plurality of wireless communication modules to make sure that there is no interference among the signals of a plurality of antennas. However, in practical applications, it is hard to avoid the interference among a plurality of antennas. It is thus clear that the existing solutions for avoiding the interference among a plurality of wireless communication modules can only be applied in specific situations such as when device volume is large, but cannot be universally applied in the multilink wireless local area network.

### SUMMARY OF THE INVENTION

Systems, methods and devices of the present invention for multilink wireless data transmission can effectively avoid the interference among two or more WLAN clients, thereby improving the stability and reliability of the multilink wireless local area network. In order to solve the technical problem above, the following technical solutions are provided:

According to one aspect of the present invention, a multilink wireless data transmission device comprises a control module and two or more WLAN clients, wherein the control module is constructed to control the WLAN clients to enable the data transmission states of those of the WLAN clients, which are not in an idle state, to be the same, and wherein the data transmission states comprise a receiving state and a sending state.

The control module is configure to control the WLAN clients which need to receive data to switch to the receiving state when a downlink triggering condition is met, and to control the WLAN clients which need to send data to switch to the sending state when an uplink triggering condition is met. Furthermore, the control module is configured to control the WLAN clients which need to receive data to send downlink transmission instructions to respectively corresponding access points thereof and receive downlink messages from the access points when the WLAN clients have finished sending all uplink messages or meet a first timing condition. Furthermore, the control module is configured to control the WLAN clients which need to send data to send uplink messages to respectively corresponding access points thereof when the WLAN clients have finished receiving all downlink messages or meet a second timing condition.

According to another embodiment of the present invention, a multilink wireless data transmission method for controlling the wireless data transmission between two or more WLAN clients and respectively corresponding access points thereof, comprises enabling the data transmission states of those of the WLAN clients, which are not in an idle state, to be the same, wherein the data transmission states comprise a receiving state and a sending state.

The enabling the data transmission states of the WLAN clients, which are not in an idle state, to be the same comprises switching the WLAN clients, which need to receive data, to the receiving state from the sending state when the downlink triggering condition is met, and switching the WLAN clients, which need to send data, to the sending state from the receiving state when the uplink triggering condition is met.

Furthermore, the downlink triggering condition is that the WLAN clients have finished sending all uplink messages or it is the first timing condition. Furthermore, switching the WLAN clients, which need to receive data, to the receiving state from the sending state comprises controlling the WLAN clients, which need to receive data, to send downlink transmission instructions to the access points and receive the downlink messages from the access points.

Furthermore, the uplink triggering condition is that the WLAN clients have finished receiving all downlink messages or it is the second timing condition. Furthermore, switching the WLAN clients, which need to send data, to the sending state from the receiving state comprises controlling the WLAN clients, which need to send data, to send uplink messages to the access points.

According to another embodiment of the present invention, a wireless communication system comprises a multilink wireless data transmission device and at least two access points respectively corresponding to the WLAN clients.

The access points are configured to send downlink messages to the WLAN clients only when receiving the downlink transmission instructions sent from the corresponding WLAN clients.

Furthermore, the WLAN clients send first reply messages to the access points corresponding thereto after receiving the downlink messages, and the access points send second reply messages to the WLAN clients corresponding thereto after receiving the uplink messages.

According to another embodiment of the present invention, a computer-readable medium store computer-readable codes used for implementing the multilink wireless data transmission method.

According to yet another embodiment of the present invention, a computer program product contains computer-readable codes used for implementing the multilink wireless data transmission method above.

The advantages of the present invention are that two or more WLAN clients only perform uplink data transmission or only perform downlink data receiving within a time period, avoiding the situation where the uplink data transmission and the downlink data receiving of two or more WLAN clients are overlapped. Therefore, the interference problem among two or more WLAN clients can be effectively solved, thereby improving the stability and reliability of the multilink wireless local area network.

### BRIEF DESCRIPTION OF THE DRAWINGS

FIG. 1 is a structural schematic diagram of a multilink wireless local area network known in the art.

FIG. 2 is a schematic diagram of a multilink wireless data transmission device according to one embodiment of the present invention.

FIG. 3 is an exemplary schematic flowchart of a multilink wireless data transmission method according to one embodiment of the present invention.

FIG. 4 is a schematic diagram illustrating the signal timing of multilink wireless data transmission according to one embodiment of the present invention.

FIG. 5 is a variation of the signal timing diagram shown in FIG. 4.

FIG. 6 is a schematic diagram of the signal timing of wireless data transmission with reply messages according to one embodiment of the present invention.

### DETAILED DESCRIPTION OF THE PRESENTLY PREFERRED EMBODIMENTS

In order to make objectives, technical solutions and advantages of the embodiments of the present invention more apparent, the embodiments of the present invention will be further described in detail hereinafter by way of example.

By carefully analyzing the multilink wireless local area network, the inventors discovered that the interference among two or more WLAN clients generally occurs in the situation where the uplink data transmission and downlink data receiving performed by two or more WLAN clients are overlapped. For example, for two WLAN clients, when one thereof sends uplink data while another receives downlink data, the stronger transmission power of the link sending uplink data will interfere with the link receiving downlink data with a lower power. However, when two WLAN clients are performing the uplink data transmission simultaneously or performing the downlink data receiving simultaneously, the interference among different wireless communication modules is smaller.

Therefore, as long as each wireless communication module is not in the states of receiving data and sending data simultaneously, the interference among them can be reduced greatly. The wireless communication module generally has three states: idle state, receiving data state and sending data state. Since the wireless communication module in an idle state neither receives data nor sends data, it will not interfere with other communication modules. Then, when the data transmission states of various wireless communication modules which are not in an idle state are the same, i.e. they are in a receiving state simultaneously or in a sending state simultaneously, the interference among these modules can be reduced greatly.

The technical solution of the present invention separates the uplink data transmission process and the downlink data receiving process of two or more WLAN clients, thereby making two or more WLAN clients only perform uplink data transmission (sending state) simultaneously or only perform downlink data receiving (receiving state) simultaneously, and thereby avoiding the situation where the uplink data transmission and downlink data receiving of two or more WLAN clients are overlapped. Consequently, the interference problem among different WLAN clients can be solved effectively, improving the stability and reliability of the multilink wireless local area network.

In the following paragraphs, the presently preferred embodiments of the present invention will be explained in detail in conjunction with the drawings. FIG. 2 is a schematic diagram of a multilink wireless data transmission device 100 according to one embodiment of the present invention. The device 100 comprises a first WLAN client 10, a second WLAN client 20 and a control module 50.

For the sake of simplicity, the present embodiment comprises two WLAN clients; however, the device of the present invention can include two or more WLAN clients. For the situations involving more than two WLAN clients, it can be learned by those skilled in the art according to the present embodiment and other parts of this description how to apply the principle and technical solution of the present invention under such situations, and such applications would not depend on inventive effort beyond the present invention.

As shown in FIG. 2, the control module 50 performs data information exchange respectively with the first WLAN client 10 and second WLAN client 20. The first WLAN client 10 and the second WLAN client 20 can be identical wireless communication modules, or different wireless communication modules.

For the present embodiment, the control module 50 is configured to control the first and second WLAN clients 10 and 20 to enable them to be in the same data transmission state when the first and second WLAN clients 10, 20 are not in an idle state. The data transmission state comprises a receiving state and a sending state.

Referring to the principle of the present invention described above, when the data transmission states of the first WLAN client 10 and the second WLAN client 20 are the same, i.e., they are in a receiving state simultaneously or in a sending state simultaneously, the interference among these modules can be reduced greatly.

Again in accordance with the principle of the present invention mentioned above, in an embodiment in which the device 100 includes more than two WLAN clients (such as three or more), it is possible that one or a part of the WLAN clients is possibly in an idle state. In that case, the control module 50 controls other WLAN clients, which are not in an idle state, to be in same data transmission states, i.e., to be in a sending state simultaneously or in a receiving state simultaneously.

Referring to FIG. 2 again, in order to control the first and second WLAN clients 10 and 20, the control module 50 is configured to control the first and second WLAN clients 10 and 20 to switch to the receiving state from the sending state when a downlink triggering condition is met, and to control the first and second WLAN clients 10 and 20 to switch to the sending state from the receiving state when an uplink triggering condition is met.

The downlink triggering condition comprises when the first and second WLAN clients 10 and 20 have finished sending both uplink messages, or when it is a first timing condition. The uplink triggering condition comprises when the first and second WLAN clients 10 and 20 have finished receiving both downlink messages, or when it is a second timing condition.

Controlling the WLAN clients to switch to the receiving state from the sending state includes, in one embodiment, controlling the WLAN clients to send uplink transmission instructions to the respectively corresponding access points thereof, and receive downlink messages from the respectively corresponding access points. Controlling the WLAN clients to switch to the sending state from the receiving state includes, in one embodiment, controlling the WLAN clients to send uplink messages to the two or more access points.

Therefore, the control module 50 is configured to control the WLAN clients to send downlink transmission instructions to the respectively corresponding access points and receive downlink messages therefrom when the WLAN clients have finished sending the uplink messages or meet the first timing condition.

Furthermore, it is also configured to control the WLAN clients to send uplink messages to the two or more access points when the WLAN clients have finished receiving the downlink messages or meet the second timing condition. Having finished receiving the downlink messages can mean that receiving of the longer one of the downlink messages received by the first WLAN client and second WLAN client is finished, or receiving of the last one of the received downlink messages is finished. Having finished sending all the uplink messages can mean that sending of the longer one of the uplink messages sent by the first and second WLAN clients is finished, or sending of the last one of the uplink messages which is sent is finished. How to determine having finished receiving all the downlink messages or having finished sending all the uplink messages will be described in conjunction with examples hereinafter.

In the manner above, the duration of each sending state or receiving state of the WLAN clients may be different, depending on the length of the uplink messages or downlink messages, the initiation time of the receiving or sending, etc.

An alternative method is to send or receive in a fixed time period, which is equivalent to performing temporal synchronization among the WLAN clients. In such a situation, each WLAN client is set as: sending data in sending time periods, and receiving data in receiving time periods. Such sending time periods and receiving time periods are alternately spaced. Thus, the first timing condition refers to the end moments of the sending time periods, and the second timing condition refers to the end moments of the receiving time periods. It can be understood by those skilled in the art according to the description herein that the temporal synchronization mechanism used in the present invention can be implemented by applying any of the existing appropriate techniques without additional inventive work.

Thus, when a transmission error occurs (such as an error in sending a downlink message from an access point, or an access point not having an idle bandwidth), the WLAN clients will not wait until they have finished receiving the downlink messages, but send uplink messages to the access points directly when meeting the second timing condition.

It can be learned by those skilled in the art according to the description above that for the implementation comprising more than two WLAN clients, the control module can control these WLAN clients in the same way.

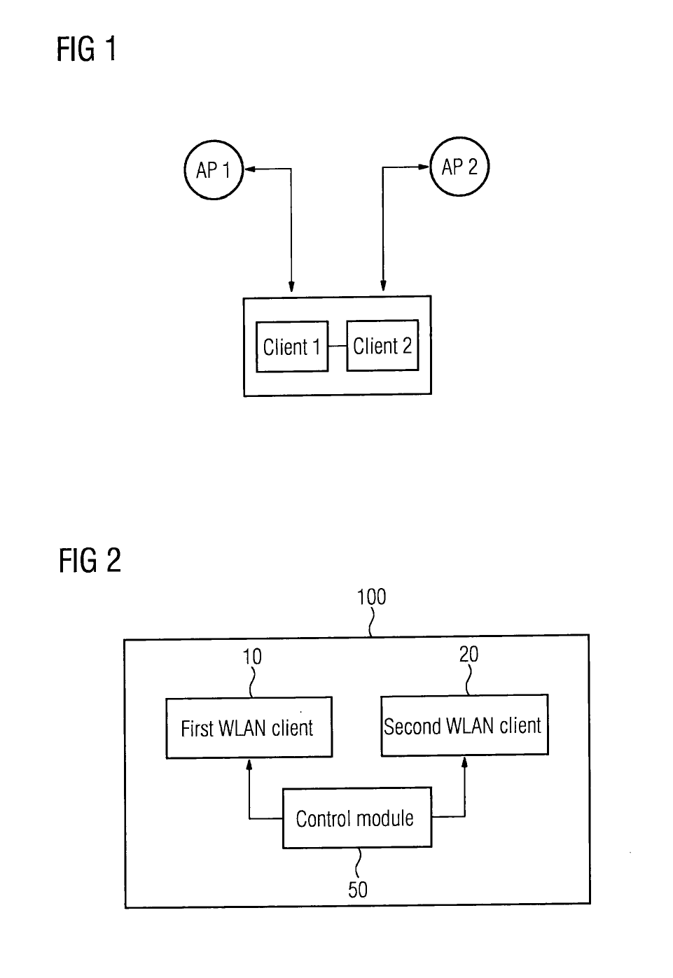

In another embodiment of the present invention, a multilink wireless data transmission method includes controlling the wireless data transmission between two or more WLAN clients (e.g., the WLANs shown in FIGS. 1 and 2) and corresponding access points (e.g., the APs shown in FIG. 1). Similarly, although the specific example which will be described hereinafter comprises two WLANs, it can be understood by those skilled in the art that the method of the present embodiment can be applicable in the situation comprising more than two WLAN clients as well without any inventive effort beyond the present invention. The method of the present embodiment enables the data transmission states of the WLAN clients, which are not in an idle state, to be the same. Similarly, the data transmission states comprise a receiving state and a sending state.

Furthermore, the enabling the data transmission states of the WLAN clients, which are not in an idle state, to be the same comprises switching the WLAN clients to the receiving state from the sending state when the downlink triggering condition is met, and switching the WLAN clients to the sending state from the receiving state when the uplink triggering condition is met.

Specifically, the uplink and downlink triggering conditions are identical to those in the description of the device shown in FIG. 2, that is, the downlink triggering condition is that the WLAN clients have finished sending all the uplink messages or it is the first timing condition, and the uplink triggering condition is that the WLAN clients have finished receiving all the downlink messages, or it is the second timing condition. Similarly, switching the WLAN clients to the receiving state from the sending state comprises controlling the WLAN clients to send downlink transmission instructions to the respectively corresponding access points thereof and receiving the downlink messages from the access points. Switching the WLAN clients to the sending state from the receiving state comprises controlling the WLAN clients to send uplink messages to the access points.

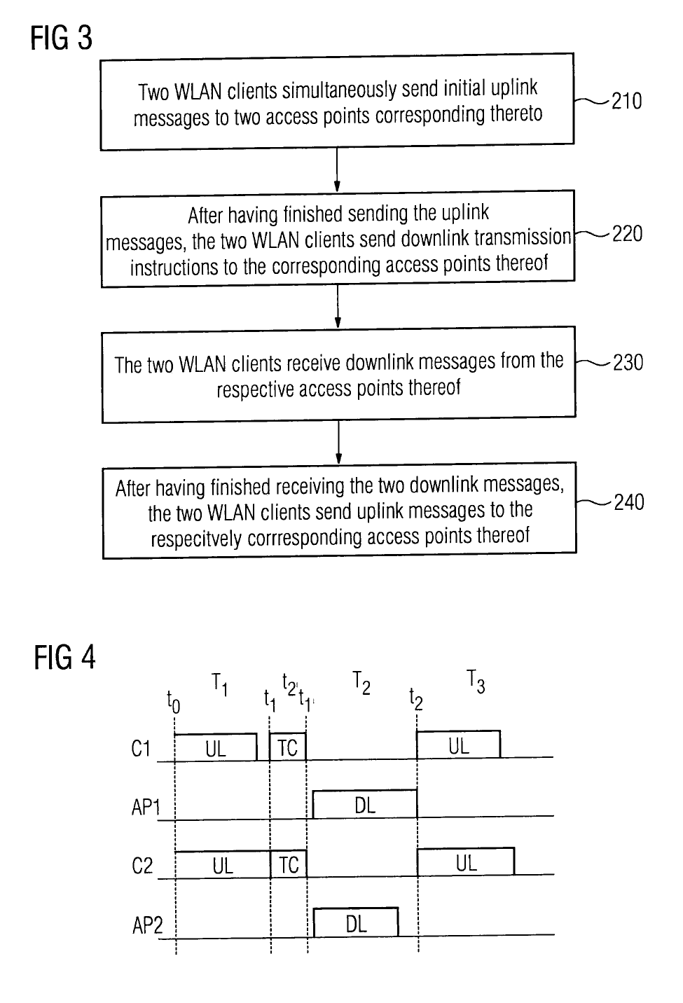

The method of the present embodiment will be described in detail hereinafter in conjunction with FIG. 3. It should be noted that although two WLAN clients are described in the example in FIG. 3, as stated above, the same principle can apply to the examples comprising more than two WLAN clients. Additionally, although the example of FIG. 3 starts with receiving data by the WLAN clients, it can be learned by those skilled in the art that it is only the selected observation window which is different during the data transmission process, and the same example can start the process with sending data.

In order to facilitate understanding, description is carried out in conjunction with FIG. 4. FIG. 4 describes a schematic diagram illustrating the signal timing of multilink wireless data transmission according to the embodiments of the present invention. For ease of description, two WLAN clients are respectively marked as C1 and C2, which can respectively correspond to the first WLAN client 10 and the second WLAN client 20 shown in FIG. 2. The access points corresponding to the two WLAN clients are a first access point and a second access point, marked respectively as AP1 and AP2. In FIG. 4, uplink messages are represented as UL, and downlink messages are represented as DL. In one embodiment, these two WLAN clients are arranged on an identical device.

In step 210, two WLAN clients (C1 and C2) simultaneously send initial uplink messages to the two access points corresponding to themselves (AP1 and AP2).

The drivers of the two WLAN clients can provide a control interface, and an external controller (such as the control module 50 of the embodiment in FIG. 2) can instruct the two WLAN clients to send initial uplink messages via the control interface.

In a WLAN system, having finished sending the uplink data, a WLAN client can automatically generate a sending success interrupt, then when all the WLAN clients have sent the sending success interrupt, this indicates that the sending of all the uplink messages has been finished.

As shown in step 220, when the sending of all the uplink messages in two WLANs has been finished, i.e., meeting the downlink triggering condition, then the two WLAN clients send downlink transmission instructions (shown as TC in FIG. 4) to the corresponding access point (AP1). It should be noted that although the downlink transmission instructions are represented as TC in FIG. 4, this does not mean that the downlink transmission instructions sent by the two WLAN clients are the same. It can be understood by those skilled in the art that the downlink transmission instructions sent from each WLAN client can be different according to different devices and application environments.

As shown in FIG. 4, when the actions between two WLAN clients can be well synchronized, then having finished sending all the uplink messages can mean having finished sending the longer one of the two uplink messages. In other embodiments, if two WLAN clients do not perform sending simultaneously, the downlink triggering condition can also be having finished sending the last one of the two uplink messages.

As stated above, for example, for the embodiment shown in FIG. 2, the first WLAN client 10 and second WLAN client 20 can send the sending success interrupt to the control module 50. When the control module 50 has received the sending success interrupts of all the WLAN clients, then it is considered that the sending of the uplink messages of the first and second WLAN clients 10, 20 has been finished.

After sending the downlink transmission instructions TC, the two WLAN clients C1 and C2 respectively receive the downlink messages from the two access points AP1 and AP2, as shown in step 230.

After having received the downlink transmission instructions, the two access points AP1 and AP2 start to transmit the downlink messages to the respectively corresponding WLAN clients. Since the transmission actions of the access points are triggered by the WLAN clients, it is ensured that the access points cannot transmit downlink messages to the WLAN clients when the WLAN clients are sending uplink messages.

In step 240, having finished receiving all the downlink messages, the two WLAN clients send another uplink message to the corresponding access points.

As shown in FIG. 4, in the situation where the actions between the two WLAN clients are well synchronized, having finished receiving both downlink messages means having finished receiving the longer one of the two downlink messages.

In other embodiments, if the two WLAN clients do not perform receiving synchronously, then having finished receiving all the downlink messages can also mean having finished sending the last one of the two uplink messages. For example, if there is an error in the time when the two access points receive the downlink transmission instructions, or after receiving the downlink transmission instruction, a certain access point does not send a downlink message immediately but waits until the downlink thereof is idle then starts to send the downlink messages, thereby a possible result is that the downlink message sending by the two access points is not completely synchronized.

In a WLAN system, after having received the downlink data, a WLAN client can automatically generate a receiving success interrupt. Therefore, when all the WLAN clients have generated the receiving success interrupt, then the two WLAN clients send uplink messages, if meeting the uplink triggering condition.

That is, only when all the WLAN clients have finished receiving all the downlink messages, the WLAN clients continue to send the uplink messages to the respective access points thereof. By setting the uplink triggering condition, it can be ensured that in a plurality of WLAN clients, only uplink data transmission is performed without receiving downlink messages, avoiding the interference between uplink data transmission and downlink data receiving.

According to the description above, it is clear that the WLAN clients only perform uplink data transmission or only perform downlink data receiving within a time period.

Referring to FIG. 4, at the moment of t₀, the two WLAN clients C1 and C2 start to send uplink messages (uploading data). At the moment of t₁, the sending of all the uplink messages of the two WLAN clients has been finished. At this moment, the two WLAN clients start to send downlink transmission instructions TC. After having received the instructions, the access points AP1 and AP2 start to send downlink messages to the respective WLAN clients thereof, and the WLAN clients start to receive downlink messages. At the moment of t₂, the receiving of all the downlink messages of the two WLAN clients has been finished. At this moment, the WLAN clients start another sending process again, in turn alternately sending and receiving as stated above.

As shown in FIG. 4, within the time period of T₁ (t₀-t₁), the two WLAN clients C1 and C2 are both sending data, i.e., they are in a sending state of data transmission. Within the time period of T2 (t₁-t₂), the two WLAN clients are both sending downlink transmission instructions (TC) and receiving data.

As shown in FIG. 4, the two WLAN clients send downlink transmission instructions simultaneously at the moment of t₂; however the present invention does not strictly restrict the synchronization requirements of sending downlink transmission instructions, as long as there is no conflict between sending downlink transmission instructions and receiving downlink messages. It can be learned by those skilled in the art that taking the sending downlink transmission instruction as a state of sending data within a short time period can avoid the conflict with receiving downlink messages with reference to the method above. For example, in FIG. 4, at the moment of t₁′, the two WLAN clients have finished sending the downlink transmission instructions, then start to receive the downlink messages, then within the time period of T₂′, the WLAN clients C1 and C2 are in a sending state. Within the time period of T₂, the WLAN clients C1 and C2 are in a receiving state. At the moment of t₂, the WLAN clients C1 and C2 have finished receiving the downlink messages, then start to send uplink messages again, then within the time period of T₃, both C1 and C2 are in a sending state.

It can be understood by those skilled in the art, for the situation of taking having finished receiving all the downlink messages and having finished sending all the downlink messages as the triggering condition (as in the example shown in FIG. 4), the requirements for synchronization between the WLAN clients are not extremely strict, as long as it does not cause the state of co-existence of sending and receiving between the clients. For the idle state between sending and receiving, no interference will be resulted in as stated above, so an appropriate idle state is allowed, as long as such an idle state will not result in the state of co-existence of sending and receiving as described above (for example, the time of the idle state is too long or too short).

As a result, it can be seen apparently from FIG. 4 that uplink data transmission and downlink data reception are performed respectively within different time periods, avoiding the situation where uplink data transmission and downlink data reception performed by a plurality of WLAN clients are overlapped. Therefore, the interference problem among a plurality of WLAN clients can be solved effectively, thereby improving the stability and reliability of the multilink wireless local area network.

As mentioned above, the downlink triggering condition can be the first timing condition, while the uplink triggering condition can be the second timing condition. In such a situation, the first time period can be set as sending data, and the second time period as receiving data. At this moment, the timing diagram of the process is similar to FIG. 4, only with the switching triggering condition of sending and receiving changed.

For example, it is set that both WLAN clients C1 and C2 are starting to send uplink messages at the moment of t₀. When the moment of t₁ arrives, the sending of uplink messages will be paused; in turn the downlink transmission instructions TC are sent, then receiving the downlink messages transmitted from the access points is started. At the moment of t₂, the receiving of downlink messages is paused; in turn uplink messages are sent. As such, the processes above are performed alternately.

In the situation of using timing as the triggering condition, the WLAN clients can record the location where the uplink messages and downlink messages are paused, whereby the uplink messages can be sent continuously from the paused location, or the corresponding access points are notified to transmit downlink messages from the paused location. Also, a shorter length of messages can be set or a longer timing duration can be set, so as to complete the uplink message sending or downlink message receiving within each time period. Such a data transmission method of resuming from breakpoint is common knowledge of those skilled in the art, and it is not the content to be described in the present invention, and accordingly it will not be described in detail.

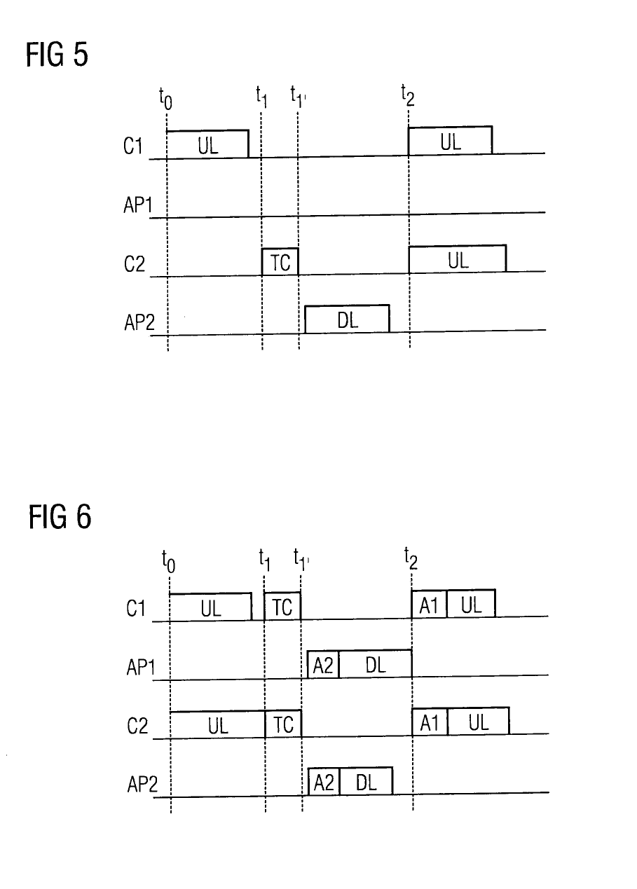

It is described in the timing diagram in FIG. 4 that both WLAN clients C1 and C2 have data exchange with the respective access points AP1 and AP2 thereof, i.e., sending data as well as receiving data. FIG. 5 shows a change of the timing diagram of FIG. 4, i.e., one WLAN client only sends data to an access point (like C1 and AP1 in FIG. 5), while another WLAN client only receives data transmitted from an access point (like C2 and AP2 in FIG. 5). For example, the client C1 is uploading a file, while the client C2 is downloading a file. There may be a similar situation for the situations involving more than two WLAN clients, i.e. a part of the clients only receives data, while the other part only sends data.

In the situation shown in FIG. 5, when the client C1 is sending an uplink message to AP1 (t₀ to t₂), the client C2 is in an idle state. Similarly to the description above, having finished sending the uplink message of C1 or meeting the first timing condition (such as the moment t₁ in FIG. 5), the client C2 sends an uplink transmission instruction TC to the access point AP2, then receives the downlink message sent by AP2; and the client C1 is in an idle state within this time period (t₁ to t₂). When the client C2 has finished receiving the downlink message or when the second timing condition is met, such as the moment t₂ in FIG. 5, then the client C2 is in an idle state again. In this way, the clients C1 and C2 work alternately, avoiding the situation where the clients C1 and C2 are respectively in the sending and receiving state at the same moment and in turn causing signal interference.

In addition, as stated above, when there are three or more WLAN clients, some WLAN clients may be in an idle state. Whereas when the WLAN clients, which were originally in an idle state, switch to a non-idle state, such as similarly shown in FIG. 5 (switching to the sending state or receiving state from the idle state), these WLAN clients also switch to the sending or receiving state according to the uplink or downlink triggering condition.

In another embodiment, a wireless communication system comprises a multilink wireless data transmission device stated above (such as device 100 shown in FIG. 2) and at least two access points corresponding to the WLAN clients in the device (such as access points AP 1 and AP2 in FIGS. 1 and 4). The access points are configured to send downlink messages to the WLAN clients only after receiving the downlink transmission instructions sent from the corresponding WLAN clients.

In the current wireless communication system, when a WLAN client needs to receive a downlink message from an access point, the WLAN client generally transmits a sending request to the access point first, then the access point transmits data to the WLAN client according to the situation thereof. That is, the access point controls the process of transmission, while the WLAN client only performs receiving. Thus, if an access point (such as AP1 in FIG. 4) transmits data (a downlink message) to its corresponding WLAN client (such as C1) all the time, when there is another WLAN client (such as C2) transmitting data (an uplink message) to another access point (such as AP2), signal interference will appear.

Therefore, in the system of the present embodiment, only when all the access points have received the downlink transmission instructions TC from the WLAN clients, downlink messages are transmitted to the WLAN clients, instead of sending data all the time after receiving the sending request. Of course, it can be understood by those skilled in the art that if the access point itself does not have an idle bandwidth, sending will not be performed either.

Describing in conjunction with FIG. 4, only after the access points AP1 and AP2 respectively receive the downlink transmission instructions TC sent by the WLAN clients C1 and C2, respective downlink messages are transmitted to the clients C1 and C2. According to FIG. 4 and the description above, it can be learned that when the time period of T₃ ends, the clients C1 and C2 send downlink transmission instructions TC again to the respective access points AP1 and AP2, then the access points AP1 and AP2 respectively send another respective downlink message to the clients C1 and C2. The situation where one access point (such as AP1) transmits a downlink message to the WLAN client corresponding thereto (such as C1) while the other WLAN client (such as C1) sends an uplink message to the other access point (such as AP2) will not appear.

It can be seen that since the access points of the system in the present embodiment only send downlink data after receiving the downlink transmission instructions of the WLAN clients, the overlapping of downlink data transmission and uplink data receiving is avoided, which can effectively solve the interference problem among a plurality of WLAN clients, and improve the stability and reliability of the wireless local area network with multiple wireless communication links.

It can be understood by those skilled in the art that the example of the system comprising a multilink wireless data transmission device with more than two WLAN clients and more than two access points is similar to the example described above in conjunction with FIG. 4.

It is well known that during the running of the system in the present embodiment, various data transmission errors may appear, resulting in the failure of sending uplink messages or the failure of receiving downlink messages by the WLAN clients. For this reason, the WLAN clients in the present system can be configured to send first reply messages to the corresponding access points after receiving the downlink messages successfully; and when receiving the uplink messages successfully, the access points send second reply messages to the corresponding WLAN clients.

FIG. 6 shows a timing diagram of the data transmission between the WLAN clients and the access points with reply messages according to one embodiment of the present invention. The meanings represented by the reference signs in FIG. 6 are the same as those in FIG. 4 except: A1 represents the first reply message, i.e., a reply message corresponding to the downlink message; and A2 represents the second reply message, i.e., a reply message corresponding to the uplink message. In FIG. 6, although the two pairs of client-access points C1-AP1 and C2-AP2 both represent reply messages using A1 and A2, the reply messages sent by the clients C1 and C2 can be different, and the reply messages sent by the access points AP1 and AP2 can be different as well, depending on the specific application environment.

As shown in FIG. 6, the WLAN clients send uplink messages (UL) to the respective access points thereof. Having received the uplink messages, the access points first send the second reply messages (A2) before or while sending the downlink messages (DL) to the WLAN clients. After having received the downlink messages, the WLAN clients send the first reply messages (A1) before or while sending another uplink message.

The first reply message can be a data packet independent of the uplink message, or can be contained in an identical data packet with the uplink message. Likewise, the second reply message can be a data packet independent of the downlink message, or can be contained in an identical data packet with the downlink message. Although in FIG. 6 it is shown that the reply messages precede the uplink/downlink messages, it is just an example but not a limitation to the present invention. It is well known in the art how to generate and send a reply message, which will not be described in detail herein. The reply message can be acknowledge characters (ACK).

So, when the WLAN clients or access points do not receive messages due to transmission errors, reply messages will not be received, and can be re-sent in another time period, thus improving reliability. Improving the reliability by means of re-sending and how to realize data re-sending are common knowledge in the art, and the advantages and details thereof will not be described in detail herein.

As another example, the WLAN clients send the uplink messages when the receiving of all the downlink messages has been finished as described above. Therefore, when the WLAN client is in a receiving state (as in the time period t₂ in FIG. 4), if an access point has failed to transmit data to the WLAN client, the condition of having received all the downlink messages cannot be met. For example, the first and second WLAN clients 10 and 20 of the device shown in FIG. 2 cannot generate a receiving success interrupt, and the control module 50 cannot control the WLAN clients to enter the sending state.

According to the description above, when meeting the second timing condition, the WLAN clients suspend receiving of downlink messages but directly send uplink messages to the access points, which can overcome the problem resulting from transmission errors. However, as stated above, taking timing condition as the triggering condition sending/receiving may result in incompletion of message transmission.

To solve the problem above, the timing condition can be combined with the message transmission condition. That is, for the downlink triggering condition, having finished sending all the uplink messages, the WLAN client enters the receiving state, but when it has not finished sending by the time the first timing condition is met, the sending will be paused, and the WLAN client enters the receiving state as well. Similarly, for the uplink triggering condition, when having finished sending all the downlink messages, the WLAN client enters the sending state, but when it has not finished receiving by the time the second timing condition is met, the receiving will be paused, and the WLAN client still enters the sending state.

Although the description above implies that the sending/receiving finish conditions are judged before the timing conditions, the judgment precedence of the two conditions can be chosen according to specific application environments.

In the case of not finishing receiving/sending, the method of resuming from breakpoint can be applied as stated above, or the re-sending mechanism above, or any other appropriate methods, or a combination of the methods stated above can be applied. In the embodiments above, each WLAN client corresponds to the access point one-to-one. In actual situations, in the cause of more than two WLAN clients, it is possible that a plurality of WLAN clients is connected to one access point. It can be understood by those skilled in the art that in such a situation, one access point can only communicate with one WLAN client at a certain moment.

For example, for the case of three WLAN clients C1, C2 and C3, and two access points AP1 and AP2, C1 and C2 and AP1 and AP2 are the WLAN clients and access points shown in FIG. 4. As shown in FIG. 4, C1 and C2 communicate respectively with AP1 and AP2, while C3 communicates with AP1 as well. At a certain moment, AP1 can only perform data transmission with one of C1 and C3. Therefore, at a certain moment, there is actually one WLAN in an idle state. Such changes fall in the scope of protection of the present invention, and the same principle applies for the situation containing more WLAN clients and access points.

Also provided in the present invention is a storage medium readable by a machine (such as a computer), wherein instructions for making a machine execute a multilink wireless data transmission method described herein are stored therein.

Also provided in the present invention is a computer program product, containing computer readable instructions which can execute the multilink wireless data transmission method.

In particular, it is possible to provide a system or device provided with the storage medium on which software program codes performing the functions of any one of the abovementioned embodiments are stored, and to enable the computer (or CPU or MPU) of the system or device to read out and execute the program codes stored in the storage medium.

In this case, the program codes read from the storage medium per se are capable of performing the functions of any one of the abovementioned embodiments; thus the program codes and the storage medium storing the program codes constitute a part of the present invention.

The storage medium embodiments for providing the program codes include floppy disks, hard disks, magneto optical disks, compact disks (such as CD-ROM, CD-R, CD-RW, DVD-ROM, DVD-RAM, DVD-RW, DVD+RW), magnetic tape, nonvolatile storage card and ROM. Optionally, the program codes can be downloaded from a server computer via communication networks.

In addition, it should be clear that the functions of any one of the abovementioned embodiments can be performed not only by executing the program codes read by the computer but also by enabling the operation system operated on the computer, etc. to perform a part of or all of the actual operations based on the instructions of the program codes.

What are mentioned above are merely the preferable exemplary embodiments of the present invention, and they are not intended to limit the protection scope of the present invention. Appropriate improvements to the preferred embodiments of the present invention can be made during particular implementation processes to meet particular requirements of a particular situation. Therefore it can be understood that particular embodiments of the present invention described herein are merely demonstrations but not used for limiting the scope of protection of the present invention.

What is claimed is:

1-15. (canceled)

16. A multilink wireless data transmission device comprising a control module and two or more WLAN clients, wherein said control module is constructed to control said WLAN clients to enable the data transmission states of those of the WLAN clients which are not in an idle state to be the same, and said data transmission states comprise a receiving state and a sending state.

17. The multilink wireless data transmission device of claim 16, wherein the control module is configured to control at least one of the two or more WLAN clients, which need to receive data, to switch to the receiving state when a downlink triggering condition is triggered, and to control at least one of the two or more WLAN clients, which need to send data, to switch to the sending state when an uplink triggering condition is triggered.

18. The multilink wireless data transmission device of claim 17, wherein the control module is configured to control at least one of the two or more WLAN clients, which need to receive data, to send downlink transmission instructions to respectively corresponding access points and receive downlink messages from the access points when the at least one of the two or more WLAN clients has finished sending all uplink messages or when a first timing condition is triggered.

19. The multilink wireless data transmission device of claim 18, wherein the control module is configured to control at least one of the two or more WLAN clients, which need to send data, to send uplink messages to respectively corresponding access points when the at least one of the two or more WLAN clients has finished receiving all downlink messages or when a second timing condition is triggered.

20. A wireless data transmission method for controlling the wireless data transmission between two or more WLAN clients and respectively corresponding access points, the method comprising enabling the data transmission states of those of the WLAN clients, which are not in an idle state, to be the same, wherein said data transmission states comprise a receiving state and a sending state.

21. The multilink wireless data transmission method of claim 20, wherein the enabling the data transmission states of the WLAN clients that are not in an idle state to be the same comprises switching the WLAN clients, which need to receive data, to the receiving state when meeting the downlink triggering condition and switching the WLAN clients, which need to send data, to the sending state when meeting the uplink triggering condition.

22. The multilink wireless data transmission method of claim 21, wherein the downlink triggering condition includes when the WLAN clients have finished sending all the uplink messages or when the first timing condition is triggered.

23. The multilink wireless data transmission method of claim 22, wherein switching the WLAN clients, which need to receive data, to the receiving state comprises controlling the WLAN clients, which need to receive data, to send downlink transmission instructions to the access points and receive downlink messages from the access points.

24. The multilink wireless data transmission method of claim 21, wherein the uplink triggering condition includes when the WLAN clients have finished receiving all the downlink messages or when the second timing condition is triggered.

25. The multilink wireless data transmission method of claim 24, wherein switching the WLAN clients, which need to send data, to the sending state comprises controlling the WLAN clients, which need to send data, to send uplink messages to the access points.

26. A wireless communication system comprising a multilink wireless data transmission device of claim 16 and at least two access points respectively corresponding to the WLAN clients.

27. The wireless communication system of claim 26, wherein the access points are configured to send downlink messages to the WLAN clients only when receiving the downlink transmission instructions sent from the corresponding WLAN clients.

28. The wireless communication system of claim 26, wherein the WLAN clients send first reply messages to the corresponding access points after receiving the downlink messages, and wherein the access points send second reply messages to the corresponding WLAN clients after receiving the uplink messages.

29. A non-transitory computer-readable medium storing computer-readable codes used for implementing the method of claim 20.

30. A computer program product containing non-transitory computer-readable codes used for implementing the method of claim 20.
